(19) United States
(12) Patent Application Publication
(10) Pub. No.: US 2018/0133807 A1
(43) Pub. Date: May 17, 2018

(54) PROCESSING APPARATUS AND PROCESSING METHOD

(71) Applicant: Okuma Corporation, Niwa-Gun (JP)

(72) Inventors: Eiji SHAMOTO, Nagoya-Shi (JP); Takashi Ueda, Nagoya-Shi (JP); Seiei Yamamoto, Niwa-Gun (JP)

(73) Assignee: Okuma Corporation, Niwa-Gun (JP)

(21) Appl. No.: 15/790,218

(22) Filed: Oct. 23, 2017

(30) Foreign Application Priority Data
Nov. 16, 2016 (JP) 2016-223470

(51) Int. Cl. B23B 29/12; B23K 26/00; C21D 1/09; B23B 1/00; B23B 5/36

(52) U.S. Cl. CPC B23B 29/125; B23K 26/0063; C21D 9/28; B23B 1/00; B23B 5/36; C21D 1/09

(57) ABSTRACT

A processing apparatus includes a cutting tool that processes a clamped workpiece, a quenching unit capable of emitting a laser beam, and a vibration cutting unit capable of vibrating a distal end with a vibration cutting tool mounted thereon. The cutting tool, the quenching unit, and the vibration cutting unit are movable relative to the workpiece. The cutting tool cuts the workpiece before being quenched. The quenching unit applies laser quenching as a surface hardening treatment to the workpiece. The vibration cutting unit finishes the quenched workpiece by applying the vibration cutting tool to the workpiece while vibrating the vibration cutting tool.

### BACKGROUND

This application claims the benefit of Japanese Patent Application Number 2016-223470 filed on Nov. 16, 2016, the entirety of which is incorporated by reference.

### BACKGROUND OF THE INVENTION

### Field of the Invention

The present invention relates to a processing apparatus having both a surface hardening treatment function and a vibration processing function, and to a processing method executable by the processing apparatus.

### Description of Related Art

Lathes, milling machines, and turning centers and machining centers based thereon are heretofore known as processing apparatuses for workpieces. Each of these processing apparatuses performs rough processing to form a workpiece, such as a steel material, into a rough shape with a relatively large cutting amount, and performs finishing to achieve desired accuracy.

In some cases, a desired hardness is required for a surface of a workpiece, for example, processed by such a processing apparatus that is to be assembled in a machine or the like, and is related to a sliding part. In such cases, surface hardening treatment, such as quenching, is applied after the processing by the processing apparatus.

A known laser quenching method as an example of such surface hardening treatment is described in Japanese Patent Application Publication No. H7-252521. In this method as a method for quenching an outer circumferential surface of a tubular or cylindrical object using a laser beam, the laser beam irradiating the object has a diameter in the rotational direction thereof larger than a diameter in the longitudinal direction thereof.

As a countermeasure against a distortion or the like generated in association with the quenching, finishing after quenching is generally applied to a quenched portion of a workpiece. In this quenching method, however, the workpiece is merely quenched, and the finishing after quenching is applied by another processing apparatus. From the viewpoint of ensuring the processing accuracy of the surface of the hardened workpiece, the processing apparatus for applying the finishing after quenching is preferably capable of performing precision finishing.

As one of the precision finishing apparatuses, an elliptical vibration cutting apparatus described in Japanese Patent Application Publication No. 2008-221427 is known. This apparatus can apply precision microfabrication to a workpiece by elliptically vibrating a cutting edge of a cutting tool relative to the workpiece. The elliptical vibration cutting apparatus can perform shape forming to form hardened steel.

### SUMMARY OF THE INVENTION

The above-mentioned conventional processing apparatuses, the apparatus for performing the laser quenching, and the elliptical vibration cutting apparatus are separate apparatuses. Hence, even though the elliptical vibration cutting apparatus can perform the shape forming to form the hardened steel, the overall working time from the cutting (rough processing) before the quenching to the finishing after quenching is relatively long, and the overall cost is relatively high. In particular, in the laser quenching apparatus, the hardening depth is much smaller than those of conventional vacuum hardening and induction hardening. Thus, when the workpiece is mounted on a conventional processing apparatus for finishing after the quenching and is subjected to the finishing, the workpiece needs to be cut to a depth of a mounting error or deeper. This causes wastefulness, and can cause a lack of a necessary hardening depth remaining after the finishing. Thus, much progress has not been made in replacement of the conventional quenching. Since the elliptical vibration cutting apparatus described above performs cutting while vibrating the cutting edge, the cutting speed is difficult to be increased, and the processing efficiency is likely to be equal to or lower than that of grinding by a grinding machine and hand polishing that serve as conventional precision finishing after quenching. Thus, much progress has not been made in replacement of the conventional finishing.

In view of the above, an object of the present disclosure is to provide a processing apparatus and a processing method that can execute the processing before the surface hardening treatment, the surface hardening treatment, and the finishing after the surface hardening treatment more accurately with less time and cost.

To achieve the object described above, according to the present disclosure, a processing apparatus preferably includes a processing tool configured to process a clamped workpiece, a surface hardening treatment unit configured to apply a surface hardening treatment to the workpiece, and a vibration processing unit configured to vibrate a distal end with a vibration processing tool mounted thereon. The processing tool, the surface hardening treatment unit, and the vibration processing unit are preferably movable relative to the workpiece, and the vibration processing unit is preferably configured to perform finishing by applying the vibration processing tool to the workpiece while vibrating the vibration processing tool.

According to the present disclosure, a processing method preferably includes steps of (a) processing a workpiece in a clamped state, (b) applying a surface hardening treatment to a surface of the workpiece, (c) finishing the surface of the workpiece by applying a vibration processing tool to the surface while vibrating the vibration processing tool, and (d) unclamping the workpiece.

According to the present disclosure, the processing before the surface hardening treatment, the surface hardening treatment, and the finishing after the surface hardening treatment can be performed more accurately with less time and cost.

### BRIEF DESCRIPTION OF THE DRAWINGS

FIG. 1 is a front view of a processing apparatus according to a first embodiment of the present invention.

FIGS. 2A and 2B are schematic diagrams illustrating a longitudinal vibration and a flexural vibration, respectively, of a vibration portion of a vibration cutting unit for the processing apparatus of FIG. 1.

FIGS. 3A to 3E are schematic diagrams of cutting (microscopic cutting in a very short time of approximately one vibrational period) by the vibration portion of FIGS. 2A and 2B.

FIG. 4 is a flowchart for an operation example of the processing apparatus of FIG. 1.

FIG. 5 is a front view in the case where rough processing is applied to a workpiece on the processing apparatus of FIG. 1.

FIG. 6 is a front view in the case where quenching is applied to the workpiece on the processing apparatus of FIG. 1.

FIG. 7 is a front view in the case where finishing after quenching is applied to the workpiece on the processing apparatus of FIG. 1.

FIG. 8 is a front view of a processing apparatus according to a second embodiment of the present invention.

FIG. 9 is a schematic view of a main spindle and the periphery thereof in a processing apparatus according to a third embodiment of the present invention.

### DETAILED DESCRIPTION OF THE EMBODIMENTS

The following describes embodiments and modifications thereof according to the present invention based on the drawings where appropriate. The present invention is not limited to the embodiments and the modifications thereof described below.

A processing apparatus 1 according to a first embodiment of the present invention will be described by referring to the drawings.

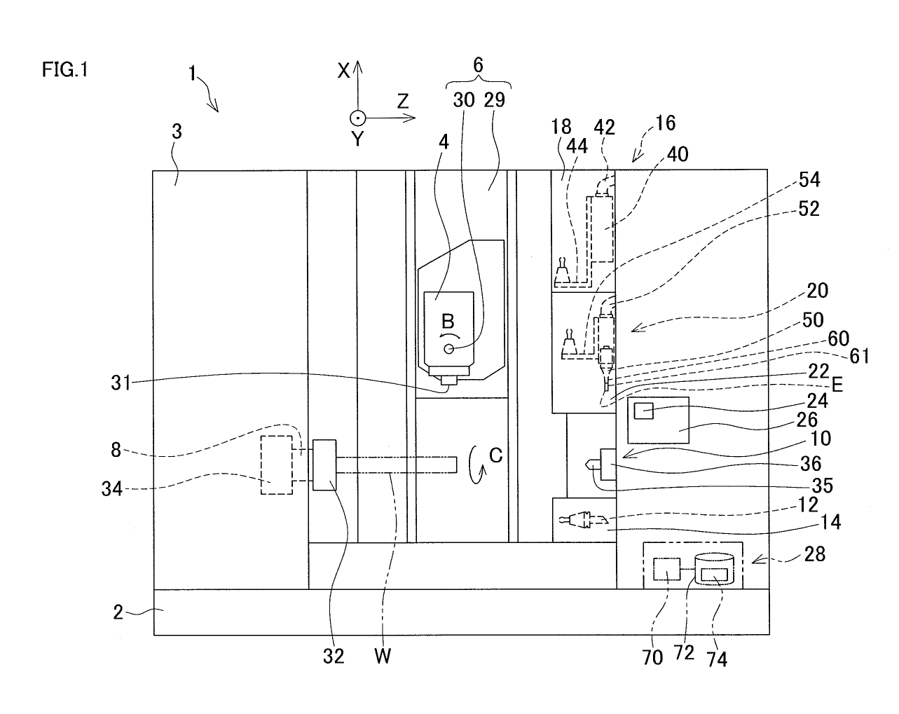

FIG. 1 is a front view of the processing apparatus 1 according to the first embodiment of the present invention.

The processing apparatus 1 is configured based on a lathe-type machine tool (combined processing machine), and includes a bed 2, a machine frame 3 fixed thereon, a main spindle head 4, a rotary feed mechanism 6 of the main spindle head 4, a workpiece spindle 8 that holds a workpiece W, a tailstock 10, one or more cutting tools 12 each serving as a tool for cutting, a pre-quenching cutting tool accommodating portion 14 serving as a cutting tool accommodating portion for accommodating the cutting tool or tools 12, a quenching unit 16 serving as a surface hardening treatment unit, a quenching unit accommodating portion 18 serving as a surface hardening treatment unit accommodating portion for accommodating the quenching unit 16, a vibration cutting unit 20 serving as a vibration processing unit for finishing after quenching, a vibration cutting unit accommodating portion 22 serving as a vibration processing unit accommodating portion for accommodating the vibration cutting unit 20, an operation panel 26 having a display portion 24 capable of displaying various types of information, and a control unit 28 for controlling the above-mentioned components.

The main spindle head 4 is mounted so as to be movable by a feed mechanism 29 of the rotary feed mechanism 6 relative to the machine frame 3 in the X-axis direction (upper-lower direction of FIG. 1), the Y-axis direction (direction orthogonal to the plane of FIG. 1), and the Z-axis direction (right-left direction of FIG. 1), and is mounted so as to be rotatable (tiltable) by a rotating mechanism of the rotary feed mechanism 6 including a rotary shaft 30, in a direction of rotation about a B-axis that is a direction of rotation about the Y-axis.

The main spindle head 4 includes, on the lower side (X-axis negative side) thereof, a tool clamping mechanism 31 serving as a unit clamping mechanism for holding, for example, the cutting tool 12. The tool clamping mechanism 31 is configured by utilizing a combination of an automatic tool changer and a tool holder generally used for, for example, a main spindle of a machining center.

The right side (tailstock 10 side) of FIG. 1 is assumed to be the positive side of the Z-axis. The back side of the plane of FIG. 1 is assumed to be the negative side of the Y-axis. When viewed in the state of FIG. 1 (from the front side), the counterclockwise direction is assumed to be the positive direction about the B-axis. The settings of the axes are mere examples. Other settings may be made, for example, by interchanging the positive and negative directions, or moving the axes to other locations. The rotary feed mechanism 6 and the workpiece spindle 8 may be disposed in any manner, provided that the main spindle head 4 is movable relative to the workpiece W. Furthermore, the relative position between each of various members, such as the cutting tool 12, mounted on the main spindle head 4 and the workpiece W may be changed to a position other than that illustrated in FIG. 1.

The workpiece spindle 8 is disposed at a lower portion on the left side (Z-axis negative side) of the machine frame 3, and includes, at a right portion thereof, a workpiece clamping mechanism 32 (workpiece chuck) for clamping the workpiece W. An end on the Z-axis negative side of the workpiece W is clamped by the workpiece clamping mechanism 32. The workpiece W may have any shape, but preferably has a cylindrical or tubular shape. The cylindrical or tubular workpiece W is preferably held with the axial direction thereof extending in the Z-axis direction.

The workpiece spindle 8 includes a workpiece rotating mechanism 34 for rotating the clamped workpiece about a C-axis serving as a rotational axis parallel to the Z-axis. When viewed from the Z-axis negative side toward the positive side, the clockwise direction is assumed to be the positive direction about the C-axis.

The tailstock 10 is disposed at a lower portion on the right side (Z-axis positive side) of the machine frame 3, and faces the workpiece spindle 8.

The tailstock 10 includes a center 35 and a telescopic mechanism 36 that extends and contracts in the Z-axis direction, and moves closer to the workpiece W to press the central axis of the workpiece W.

The cutting tool 12 cuts the workpiece W before quenching, and is used for rough processing. The cutting before quenching is performed only for the rough processing of cutting the workpiece W with a level of accuracy based on the assumption that the workpiece W is finished by finishing after quenching (described later).

The Y-axis negative direction serves as the main cutting direction of the cutting tool 12 of the processing apparatus 1. That is, in the cutting operation of the cutting tool 12, the workpiece W is rotated in the C-axis positive direction to generate a cutting motion, and the cutting tool 12 mounted on the main spindle head 4 cuts into the workpiece W in the X-axis negative direction while being relatively fed in the Z-axis negative direction to be relatively moved in the Z-axis negative direction, and thus, the workpiece W is cut.

For example, the direction of cutting of the cutting tool 12 and the rotation state can be changed as appropriate. For example, the cutting tool 12 may be moved in the Z-axis positive direction, or the Z-axis direction may be the main cutting direction. The processing before quenching (cutting before quenching) may include the rough processing (rough cutting) and finishing before quenching (finish cutting before quenching) of finishing the workpiece W that has been subjected to the rough processing. In this case, the rough processing is performed by cutting the workpiece W with a level of accuracy based on the assumption that the workpiece W is finished by the finishing before quenching, and the finishing before quenching is performed by cutting the workpiece W with a level of accuracy based on the assumption that the workpiece W is finished by finishing after quenching (described later).

The quenching unit 16 includes a laser oscillator 40 capable of emitting a laser beam L, a wiring portion 42 provided by bundling wires for supplying power, signals, and the like to the laser oscillator 40, and a joint portion 44 having an L-shape in the front view and provided on the left side of the laser oscillator 40.

The wiring portion 42 is connected to a power supply and the control unit 28 through the quenching unit accommodating portion 18.

The joint portion 44 projects leftward with respect to the laser oscillator 40, and an upper portion of the leftward projecting portion is formed into the same shape as that of the above-mentioned tool holder, so that the joint portion 44 is clamped by the tool clamping mechanism 31 of the main spindle head 4.

The joint portion 44 is clamped by the tool clamping mechanism 31, so that the quenching unit 16 is mounted on the main spindle head 4.

The quenching unit 16 accommodated in the quenching unit accommodating portion 18 can be mounted on the main spindle head 4 (tool clamping mechanism 31), and the mounted quenching unit 16 can be unclamped and accommodated in the quenching unit accommodating portion 18.

The vibration cutting unit 20 includes a vibration portion 50, a wiring portion 52 provided by bundling wires for supplying power, signals, and the like to the vibration portion 50, and a joint portion 54 provided on the left side of the vibration portion 50. The vibration cutting unit 20 is used for the finishing after quenching, but may be used for all or part of the processing before quenching (for at least either the rough processing or the finishing before quenching, but more preferably only for the finishing before quenching).

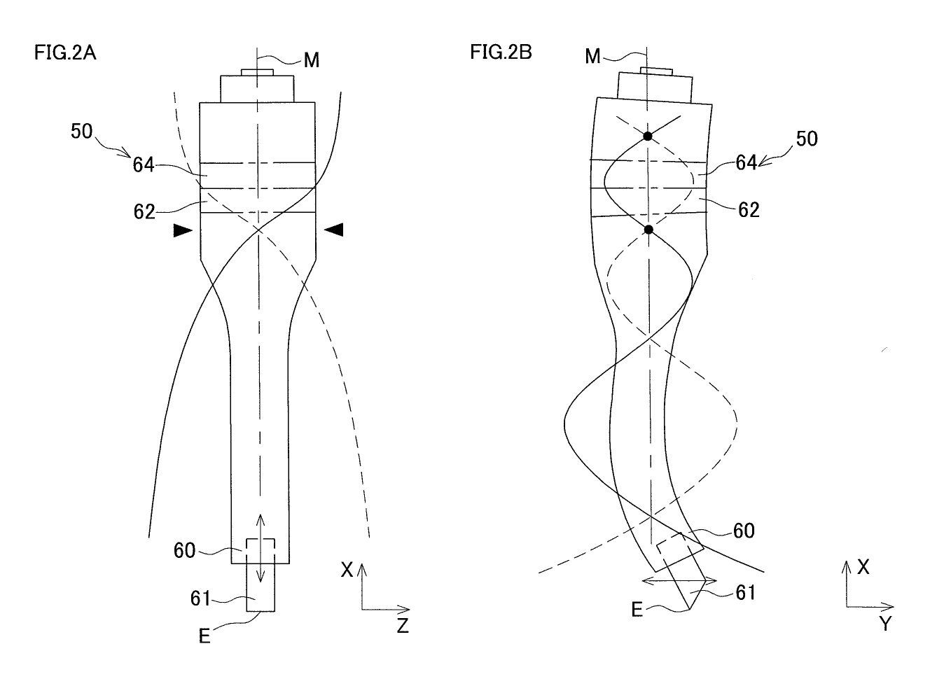

The vibration portion 50 illustrated also in FIGS. 2A and 2B includes a vibration cutting tool 61 mounted at a distal end 60 (lower end) of the vibration portion 50. The vibration cutting tool 61 serving as a vibration processing tool is a tool for ultraprecision processing (single crystal diamond tool), and endures strong elliptical vibrations (including circular vibrations) and cutting loads caused thereby. Other types of tools may be used as the vibration cutting tool 61.

The vibration portion 50 includes a first piezoelectric element 62 and a second piezoelectric element 64. Driving of the piezoelectric elements 62 and 64 can provide the vibration cutting tool 61 an elliptical vibration to elliptically vibrate a cutting edge E (tip) of the vibration cutting tool 61.

The piezoelectric element 62 may include a plurality of piezoelectric element parts, or may include only a single piezoelectric element. This also applies to the piezoelectric element 64.

The joint portion 54 is provided in the same manner as the joint portion 44 of the quenching unit 16. The joint portion 54 is clamped by the tool clamping mechanism 31, so that the vibration cutting unit 20 is mounted on the main spindle head 4. The vibration cutting unit 20 accommodated in the vibration cutting unit accommodating portion 22 can be mounted on the main spindle head 4, and the mounted vibration cutting unit 20 can be unclamped and accommodated in the vibration cutting unit accommodating portion 22.

The control unit 28 includes a processor 70 and a memory 72. The memory 72 stores a processing program 74. The processor 70 executes the processing program 74 with reference to the memory 72 to control the processing of the workpiece W.

The vibration portion 50 of the vibration cutting unit 20 has a rod-like shape, and, when mounted on the main spindle head 4, extends in a direction toward the workpiece W, that is, in the X-axis direction, and a vibration portion central axis M is oriented in the X-axis direction. The vibration cutting tool 61 is mounted at the distal end 60 (end on the workpiece W side) of the vibration portion 50 so as to extend in the X-axis direction. As a result, the X-axis negative direction serves as a cut-in direction with respect to the surface of the workpiece W.

The Y-axis negative direction serves as the main cutting direction of the vibration cutting unit 20 of the processing apparatus 1. That is, in the cutting operation of the vibration cutting unit 20, the workpiece W is rotated in the C-axis positive direction to generate a cutting motion, and the vibration cutting tool 61 cuts into the workpiece W in the X-axis negative direction while being relatively vibrated in the Y-axis direction, and thus, the workpiece W is cut. While the workpiece W is being cut in this manner, the main spindle head 4 is slowly fed in the Z-axis direction in an appropriate manner, and thus, the processed surface expands in the Z-axis direction.

The driving of the first piezoelectric element 62 vibrates the distal end 60 (vibrating portion) of the vibration portion 50 mainly in the X-axis direction, and vibrates the vibration cutting tool 61 mounted on the vibration portion 50 mainly in the X-axis direction (cut-in direction). Hereinafter, the vibration in the X-axis direction will be referred to as a longitudinal vibration in some cases.

The driving of the second piezoelectric element 64 bends the distal end 60 of the vibration portion 50 so that the distal end 60 reciprocates in the Y-axis direction, and thus vibrates the vibration cutting tool 61 mounted on the vibration portion 50 mainly in the Y-axis direction (cutting direction). To vibrate the distal end 60, at least a vibration in which the distal end 60 serves as a free end is selected, and a vibration in which both the distal end and the proximal end are free is preferably selected, as a vibration by bending. Hereinafter, the vibration in the Y-axis direction (lateral vibration) will be referred to as a flexural vibration in some cases.

The vibration portion 50 has certain resonance frequencies of the longitudinal vibration and the flexural vibration, depending on the structure thereof, such as the shape (the length in the X-axis direction, values and distribution of diameters, etc.) and the weight distribution.

The basic resonance frequencies (reference resonance frequencies) of the longitudinal vibration and the flexural vibration of the vibration portion 50 are both 16.9 kilohertz (kHz).

To efficiently vibrate the vibration cutting tool 61 by increasing the amplitude of the distal end 60, a distal end part including the distal end 60 of the vibration portion 50 is formed so as to have a tapered shape that becomes thinner as it is closer to the vibration cutting tool 61. Examples of the tapered shape include a conical horn shape, an exponential horn shape, and a stepped horn shape.

The frequency of the longitudinal vibration and the frequency of the flexural vibration are set based on the respective resonance frequencies of the vibration portion 50.

When the control unit 28 applies periodic voltages to the first and second piezoelectric elements 62 and 64, and the first and second piezoelectric elements 62 and 64 are driven, the longitudinal vibration and the flexural vibration vibrate the distal end 60 of the vibration portion 50 along an elliptical trajectory, and elliptically vibrate the vibration cutting tool 61. The vibrations for elliptically vibrating the vibration cutting tool 61 are vibrations related to certain resonance modes.

In the vibration portion 50, as illustrated by schematic wave-shaped lines (solid wave lines and dashed wave lines) in FIGS. 2A and 2B, the first piezoelectric element 62 is driven so as to vibrate the vibration cutting tool 61 in a first-order resonance mode of the longitudinal vibration (FIG. 2A), and the second piezoelectric element 64 is driven so as to vibrate the vibration cutting tool 61 in a third-order resonance mode of the flexural vibration (FIG. 2B).

The setting of such resonance modes is suited to the vibration portion 50 having the rod-like shape that is easy to handle in various aspects, such as easy mounting of the vibration cutting tool 61.

In the vibration portion 50 with the vibration cutting tool 61 mounted thereon, the flexural vibration is adjusted so as to preferably occur about the vibration portion central axis M. The adjustment is made by ensuring weight balance about the vibration portion central axis M. Although the following description is given under the assumption that the vibration portion central axis M coincides with the central axis of the flexural vibration, these axes are often actually slightly offset from each other (exact coincidence is currently difficult to be ensured).

Focusing on the distal end 60 of the vibration portion 50, to make the central axis of the vibration of the distal end 60 coincide with the vibration portion central axis M as close as possible, the vibration cutting tool 61 is mounted so as to ensure the weight balance about the vibration portion central axis M in consideration of weights of other components at the distal end 60. To keep an influence on the flexural vibration as small as possible, a heavy component is not disposed at the distal end 60.

Since the reference resonance frequencies of the longitudinal vibration and the flexural vibration of the vibration portion 50 are equal to each other, the elliptical vibration is stabilized, and the position of the node of the longitudinal vibration (part at which the vibration is smallest) roughly coincides with the position of a node of the flexural vibration at the central part (on the proximal end side of the tapered portion) of the vibration portion 50. Furthermore, nodes of the flexural vibration are present on the distal and proximal end sides of the central part. The vibration portion 50 is supported in the position of the node at the central part and in the position of a node of the flexural vibration on the proximal end side thereof (refer to black triangular marks and black circular marks in FIGS. 2A and 2B), and the vibration cutting unit 20 includes supports (not illustrated) for supporting such positions by point contact.

The frequencies of the longitudinal vibration and the flexural vibration, the resonance frequencies of the vibration portion 50, and the orders of the resonance modes are variously changeable. The reference resonance frequencies of the vibration portion 50 are preferably 1 kHz or higher, more preferably 5 kHz or higher, and still more preferably in the ultrasonic range or higher. The frequencies in the ultrasonic range may be roughly 16 kHz or higher, 17 kHz or higher, or 20 kHz or higher. A vibration at a frequency in the ultrasonic range will be referred to as an ultrasonic vibration, where appropriate.

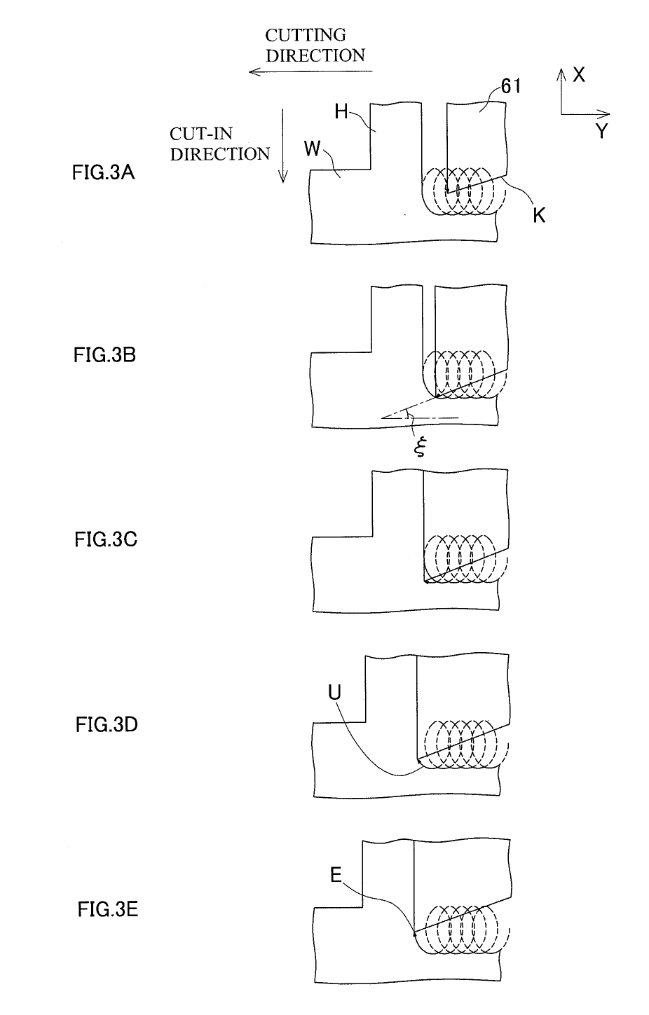

FIGS. 3A to 3E schematically illustrate a process (microscopic process in a very short time of approximately one vibrational period) in which the vibration cutting tool 61 elliptically vibrated by the vibration portion 50 cuts the workpiece W.

The vibration cutting tool 61 that has withdrawn toward the Y-axis positive side due to mainly the flexural vibration of the elliptical vibration (FIG. 3A) comes closer to the workpiece W (in the X-axis negative direction) due to mainly the longitudinal vibration, and comes in contact with the workpiece W to start the cutting (FIG. 3B). A flank face K extending from the cutting edge E so as to recede from the workpiece W is formed at a portion of the cutting edge E of the vibration cutting tool 61 on the Y-axis positive side. The cutting edge E cuts into the workpiece W at an approach angle ξ.

In the cutting operation, the vibration cutting tool 61 first comes closer to the workpiece W in the Y-axis negative direction while moving in a direction relatively close to the X-axis negative direction (FIGS. 3B and 3C). At this time, the vibration cutting tool 61 flattens the workpiece W with the cutting edge E that has microscopically observable roundness (not illustrated), and rubs a surface (already cut surface U) that has just been cut by the round portion of the cutting edge E on the flank face K side. This processing process is referred to as a burnishing process or a plowing process. This process is performed mainly during a period until the vibration cutting tool 61 comes again in contact with a cutting chip H that has already been generated until immediately before the current time (FIG. 3C), and, more in detail, is also simultaneously performed at the round portion of the cutting edge E during a material removal process to be described below.

Then, the vibration cutting tool 61 comes closer to the workpiece W in the Y-axis negative direction while moving in a direction relatively close to the X-axis positive direction (FIGS. 3C to 3E). At this time, the vibration cutting tool 61 rubs up the workpiece W, and lifts up the cutting chip H as appropriate. This processing process can be referred to as the material removal process. This process continues from the recontact of the vibration cutting tool 61 with the cutting chip H (FIG. 3C), through the lift up of the cutting chip H by the vibration cutting tool 61 (FIG. 3D), to a separation of the vibration cutting tool 61 from the cutting chip H (FIG. 3E).

After the vibration cutting tool 61 separates from the workpiece W, the material removal process in one period ends, and the state returns to the state of FIG. 3A (but in a position advanced by a distance of one period).

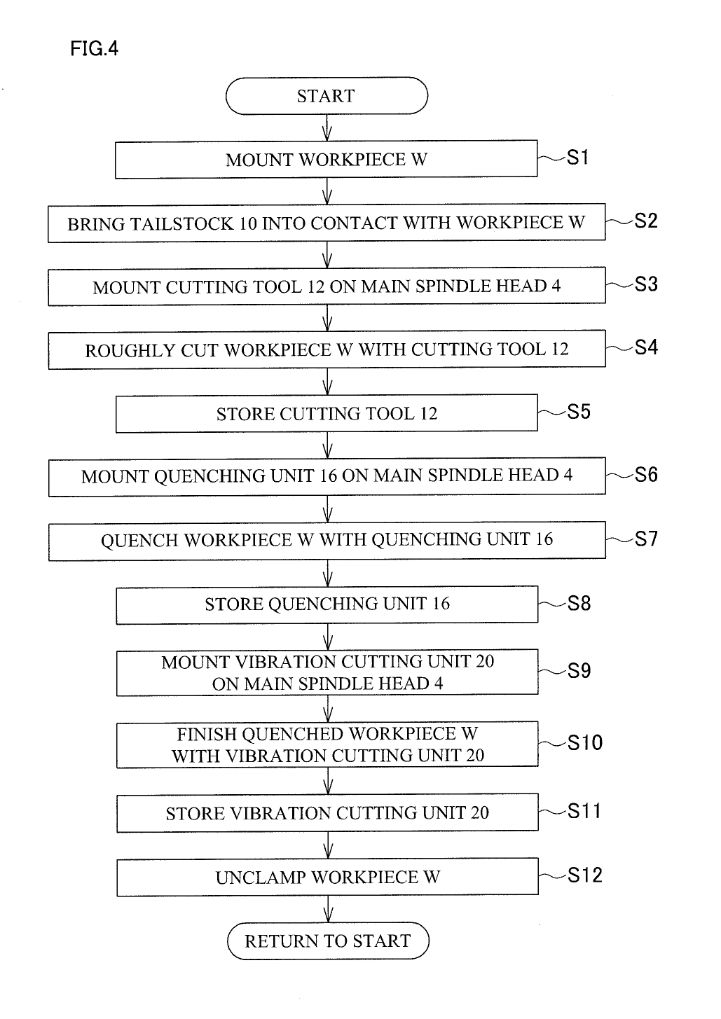

FIG. 4 is a flowchart for an operation example of the processing apparatus 1 and a processing method executed by the processing apparatus 1. Hereinafter, a step will be abbreviated as S, where appropriate.

After the workpiece W is mounted on the workpiece clamping mechanism 32 of the workpiece spindle 8 (S1, a workpiece clamping step), the control unit 28 uses the telescopic mechanism 36 to extend the tailstock 10 toward the Z-axis negative direction, and brings the center 35 into contact with the workpiece W (S2), and the control unit 28 uses the rotary feed mechanism 6 to move the main spindle head 4 to the pre-quenching cutting tool accommodating portion 14, and mounts the cutting tool 12 on the tool clamping mechanism 31 (S3).

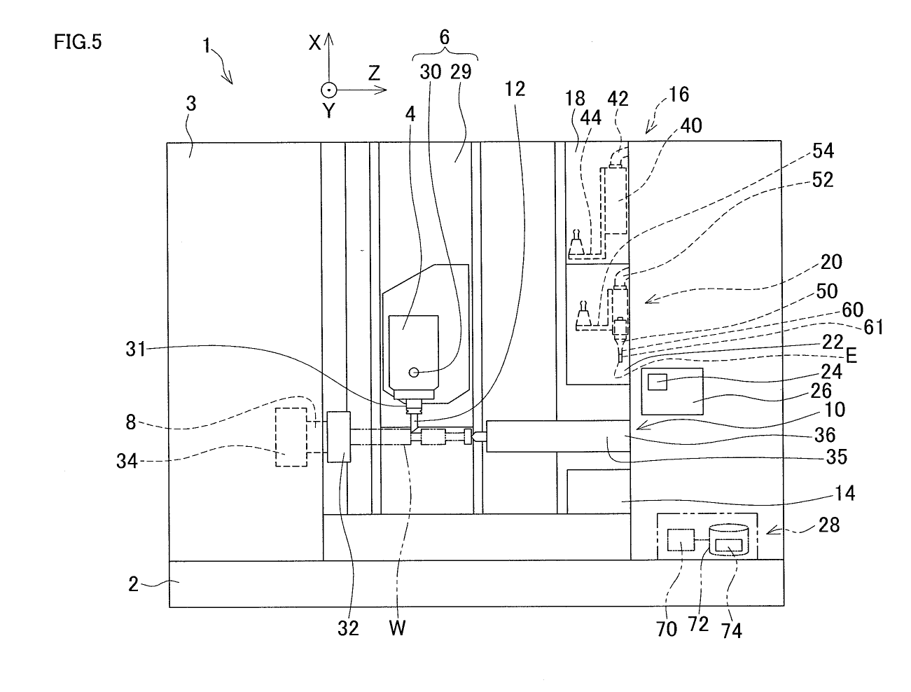

The control unit 28 moves the main spindle head 4 with the cutting tool 12 mounted thereon to a position adjacent to the workpiece W. Then, according to a rough processing procedure in accordance with a desired rough-processed shape that has been entered in advance through the operation panel 26 and stored in the memory 72, the control unit 28 applies the cutting tool 12 to the workpiece W through the main spindle head 4 to cut the workpiece W (S4, FIG. 5, cutting process as a processing step).

After the rough processing applied to the workpiece W in this manner, the control unit 28 may apply the finishing before quenching to the workpiece W with the cutting tool 12 changed or unchanged. The control unit 28 may change the cutting tool 12 in at least either the rough processing or the finishing before quenching.

Then, the control unit 28 causes the main spindle head 4 to store the cutting tool 12 (S5). Then, the control unit 28 moves the main spindle head 4 to the quenching unit accommodating portion 18, and mounts the quenching unit 16 on the tool clamping mechanism 31 (S6).

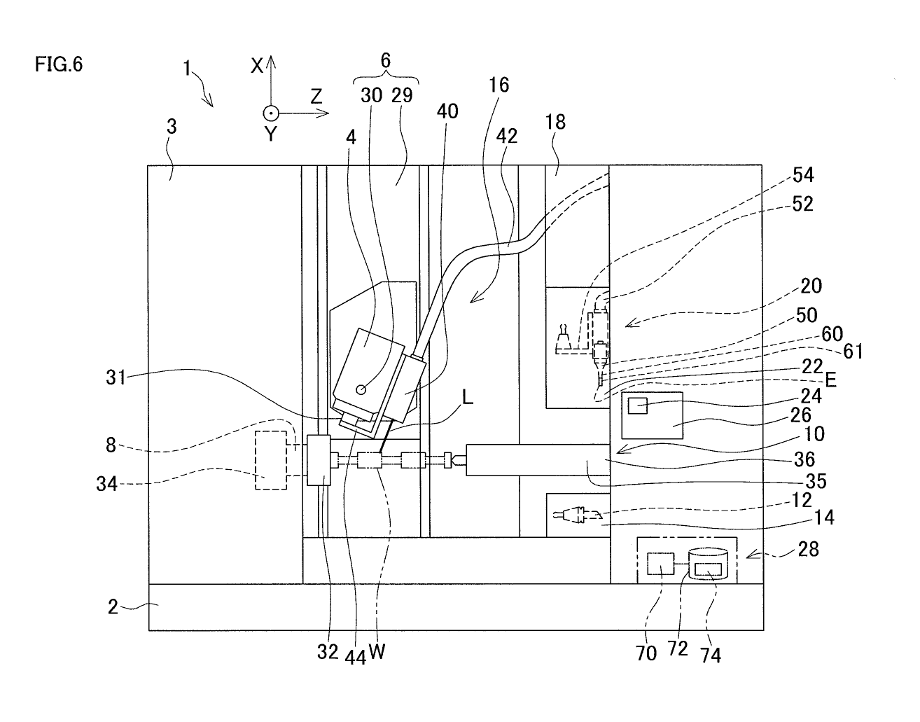

The control unit 28 moves the main spindle head 4 with the quenching unit 16 mounted thereon to a position adjacent to the workpiece W. Then, according to a quenching procedure that has been entered in advance through the operation panel 26 and stored in the memory 72, the control unit 28 applies the laser beam L generated by the laser oscillator 40 to the workpiece W through the main spindle head 4 to quench the workpiece W (S7, FIG. 6, a laser quenching step as a surface hardening treatment step).

In the quenching operation, the control unit 28 causes the laser beam L to be irradiated in a sequential manner in the circumferential direction of the workpiece W by rotating the workpiece W about the C-axis through the workpiece spindle 8, and irradiated in a sequential manner in the axial (longitudinal) direction by feeding the main spindle head 4 in the Z-axis direction (in this case, in the direction from the positive side to the negative side of the Z-axis, but may be in the direction opposite thereto). That is, the position irradiated with the laser beam L spirally moves relative to the tubular surface of the workpiece W.

The feeding speed of the laser beam L in the circumferential direction of the workpiece W is higher than the feeding speed in the axial direction serving as a direction intersecting the circumferential direction, and the temperature of one spiral turn having a belt-like shape and a width corresponding to an irradiation width of (size in the Z-axis direction of a portion irradiated with) the laser beam L substantially simultaneously reaches a quenching temperature. The feeding speed in the axial direction is set such that the temperature of the preceding spiral turn is not lower than the quenching temperature, and such that there is no portion having a temperature lower than the quenching temperature between the preceding spiral turn and the currently irradiated spiral turn. The feeding speed in the circumferential direction and the feeding speed in the axial direction are determined in advance by experimentally irradiating, for example, each material with the laser beam L. The results are stored in the memory 72 and are referred to when the irradiation of the laser beam L is controlled. Information on the material of the workpiece W can be entered from the operation panel 26. By feeding the portion irradiated with the laser beam L at a higher speed in the circumferential direction and at a lower speed in the axial direction, the surface of the workpiece W can be continuously quenched in the axial direction by increasing the temperature once, and the surface of the workpiece W is restrained or prevented from softening due to tempering around the portion irradiated with the laser beam L. However, in a surface-hardened layer of the workpiece W formed by the laser quenching, the hardness is not fully uniform, a hardness distribution is present, the hardening depth is not consistent, and unevenness of the hardening depth is present.

Even if the workpiece W is a long body other than the circular cylinder, such as a polygonal prism, the workpiece W can be quenched in the same manner as the circular cylinder. Even if the workpiece W has a large surface having long sides in the Y- and Z-axis directions, the workpiece W can be quenched in the same manner by feeding the portion irradiated with the laser beam L at a higher speed in the Y-axis direction and at a lower speed in the Z-axis direction, or at a higher speed in the Z-axis direction and at a lower speed in the Y-axis direction. Even if the workpiece W has a plurality of such large surfaces, the workpiece W can be quenched in the same manner by appropriately performing the higher-speed feeding in the Y-axis (Z-axis) direction and the lower-speed feeding in the Z-axis (Y-axis) direction for each of the surfaces.

Subsequently, the control unit 28 causes the main spindle head 4 to place the quenching unit 16 in the quenching unit accommodating portion 18 (S8). Then, the control unit 28 moves the main spindle head 4 to the vibration cutting unit accommodating portion 22, and mounts the vibration cutting unit 20 on the tool clamping mechanism 31 (S9).

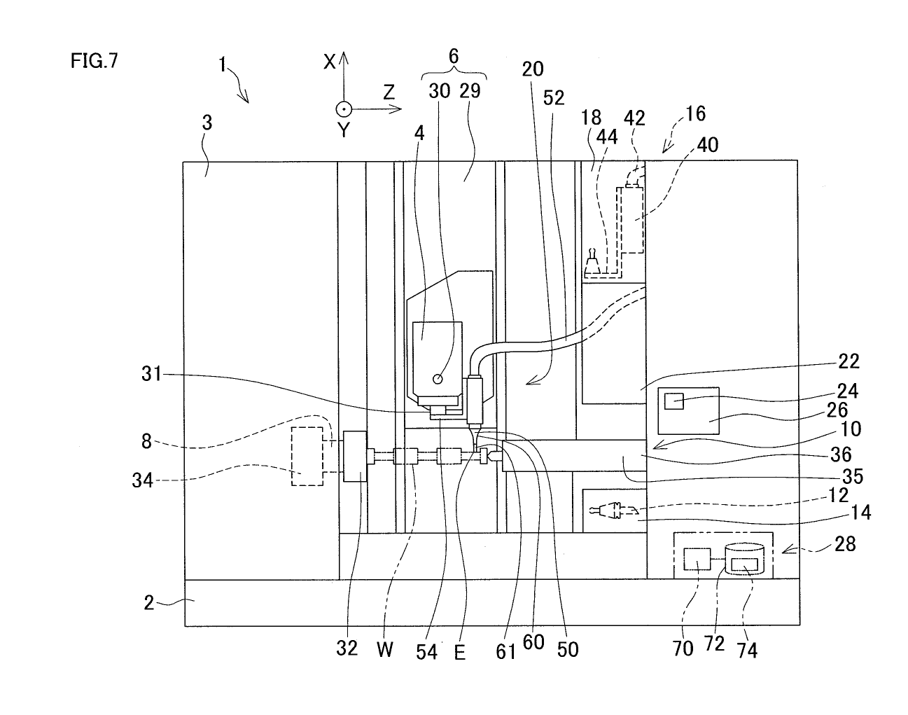

The control unit 28 moves the main spindle head 4 with the vibration cutting unit 20 mounted thereon to a position adjacent to the workpiece W. Then, according to a post-quenching finishing procedure in accordance with a desired finished shape that has been entered in advance through the operation panel 26 and stored in the memory 72, the control unit 28 applies the vibration cutting tool 61 to the workpiece W through the main spindle head 4 to finish the quenched workpiece W (S10, FIG. 7, a finishing step).

The vibration cutting tool 61 is applied to the workpiece W while being elliptically vibrated by the vibration portion 50 of the vibration cutting unit 20 through the distal end 60, and thereby, the workpiece W is cut by the vibration cutting. That is, while being longitudinally vibrated mainly in the X-axis direction and vibrated in the Y-axis direction in a flexural manner, the vibration cutting tool 61 is subjected, by the main spindle head 4, to feeding control in the Z-axis direction and position control (maximum cut depth control) in the X-axis direction according to the post-quenching finishing procedure by the main spindle head 4.

The vibration cutting described above has an effect of reducing wear of the vibration cutting tool 61 and reducing a processing force, and is used for microfabrication, precision processing, and ultraprecision processing using the very sharp vibration cutting tool 61. The vibration cutting can be expected to provide the effect of reducing the tool wear and the effect of reducing the processing force even if the workpiece W is made of a hard material, such as hardened steel.

The vibration cutting prevents the cutting tool from idling during the processing by using the sharp vibration cutting tool 61, and can also reduce a cutting force (particularly, a thrust force in the cut-in direction (X-axis positive direction)) because of the chip lifting-up effect caused by the vibration. As a result, the vibration cutting prevents the idling with a smaller cutting amount than that of conventional cutting in which the tool does not vibrate. The vibration cutting also prevents a processing error and an uncut portion even if unevenness of the hardness distribution and the hardening depth are present in the surface-hardened layer of the workpiece W.

The vibration cutting may be applied a plurality of times to the same portion of a surface of the workpiece W. However, the vibration cutting is preferably applied only once to the same portion of the surface of the workpiece W from the viewpoint of reducing the processing time, from the viewpoint of prevention of a discontinuity of the finished surface, and from the viewpoint that even a single execution of the vibration cut is sufficient to remove a hardened layer surface having a depth of several ten to several hundred micrometers.

Then, the control unit 28 causes the main spindle head 4 to place the vibration cutting unit 20 in the vibration cutting unit accommodating portion 22 (S11), and causes the workpiece clamping mechanism 32 to unclamp the workpiece W having been subjected to the finishing after quenching so that the workpiece W is removed (S12, workpiece unclamping process).

If there is the workpiece W to be subjected to the next processing, the process is repeated from S1 (returns to the start).

The processing apparatus 1 includes the workpiece clamping mechanism 32 for clamping the workpiece W, the cutting tool 12 for processing the workpiece W, the quenching unit 16 including the laser oscillator 40 capable of emitting the laser beam L, and the vibration cutting unit 20 capable of vibrating the distal end 60 with the vibration cutting tool 61 mounted thereon. The cutting tool 12, the quenching unit 16, and the vibration cutting unit 20 are movable relative to the workpiece W. The vibration cutting unit 20 performs the finishing by applying the vibration cutting tool 61 to the workpiece W while vibrating the vibration cutting tool 61.

As a result, even the workpiece W having been subjected to the quenching (surface hardening treatment) can be finished by the vibration cutting. Both the cutting (rough processing) by the cutting tool 12 before the quenching (hardening treatment) and the finishing by the vibration cutting tool 61 after the quenching (hardening treatment) are performed for one clamping of the workpiece W. As a result, compared with the case where the workpiece W is unclamped after the cutting before the hardening treatment, is hardened, and then is clamped again for the finishing thereafter, it is possible to prevent accumulation of a mounting error in the clamping for the cutting before the hardening treatment and a mounting error in the clamping for the finishing after the hardening treatment. Furthermore, a moving mechanism can be used commonly for the cutting before the hardening treatment, for the hardening treatment (laser quenching), and for the finishing after the hardening treatment. Thus, the processing apparatus 1 is reduced in size, and, combined with the effect of reduction in the number of times of clamping, the time and cost of the processing is reduced.

The vibration cutting unit 20 elliptically vibrates the vibration cutting tool 61. As a result, the finishing after quenching can be performed more accurately. That is, in the case of the elliptical vibration cutting, a force pressing up the vibration cutting tool 61 in the plowing process and a force pulling down the vibration cutting tool 61 in the material removal process cancel each other. Thus, a force in the cut-in direction (upper-lower direction) is reduced to a very small level on average, and a static variation in depth of cut (processing error) can be reduced. Furthermore, the frequency of the elliptical vibration is increased to a level at which large structures, such as the processing apparatus 1 and the workpiece W, do not respond, whereby a dynamic variation in depth of cut (surface roughness) can also be reduced to a very small level. As a result, compared with the case of applying conventional cutting and grinding, a minute depth of cut can be accurately maintained for the quenched hard surface. Hence, a hard surface can be left to an adequate depth in the laser-quenched surface which does not have a very large depth, and a highly accurate finished surface can be obtained. Moreover, highly accurate finishing can be performed by reducing the variation in depth of cut in the laser-quenched surface that is likely to have an uneven level of quenching.

The processing apparatus 1 includes the tool clamping mechanism 31 that is movable relative to the workpiece W, and capable of clamping the cutting tool 12, the quenching unit 16, and the vibration cutting unit 20. Therefore, the cutting tool 12 can be mounted on the tool clamping mechanism 31, and the workpiece W can be cut before being quenched, then, the quenching unit 16 can be mounted on the tool clamping mechanism 31, and the workpiece W can be quenched, and further, the vibration cutting unit 20 can be mounted on the tool clamping mechanism 31, and the quenched workpiece W can be finished. Thus, unlike in the case of independently placing the tools and the respective units in a movable manner, the processing apparatus 1 can be easily designed without considering overlapping of moving ranges of the units or interference therebetween when being moved, and the processing apparatus 1 is smaller in size than in the above-mentioned case because only one moving mechanism is needed for the tools and the respective units.

Moreover, the quenching unit 16 for quenching the workpiece by irradiating the workpiece W with the laser beam L serves as the surface hardening treatment unit. This configuration eliminates the necessity for deep quenching and finishing after quenching with a large amount of processing allowing for possible cumulative errors due to the clamping operations for the cutting processes before and after the hardening treatment. Thus, the time and cost of the processing is reduced. In addition, since the deep quenching is not needed, the laser quenching with a relatively small hardening depth can be used for the surface hardening treatment. Since the finishing with a large amount of processing is not needed, the vibration processing that is suitable for the precision microfabrication and is relatively difficult to ensure the amount of processing can be efficiently used for the finishing after quenching.

In the cutting method as an example of the processing method executed by the processing apparatus 1, the cutting process S4 (processing step) of processing the workpiece W is performed with the workpiece W clamped by the workpiece clamping mechanism 32 (S1), then, the laser quenching step S7 of irradiating the surface of the workpiece W with the laser beam L is performed, then, the finishing step S10 of applying the vibration cutting tool 61 to the surface of the workpiece W with the vibration cutting tool 61 vibrated, and then, the workpiece W is unclamped (S12). Thus, even the workpiece W having been subjected to the quenching (surface hardening treatment) can be finished by the vibration cutting. Furthermore, the moving mechanism can be used commonly for the cutting before quenching (cutting before the surface hardening treatment), for the laser quenching (surface hardening treatment), and for the finishing after quenching (finishing after the surface hardening treatment).

The vibration cutting tool 61 elliptically vibrates. Therefore, the finishing after quenching can be performed more accurately.

Furthermore, the cutting process S4 is performed with the cutting tool 12, the laser quenching step S7 is performed with the quenching unit 16 that includes the laser oscillator 40 capable of emitting the laser beam L, the finishing step S10 is performed with the vibration cutting unit 20 capable of vibrating the vibration cutting tool 61, and, the cutting tool 12, the quenching unit 16, and the vibration cutting unit 20 are moved relative to the workpiece W by the tool clamping mechanism 31 that allows the cutting tool 12, the quenching unit 16, and the vibration cutting unit 20 to be mounted thereon. Thus, unlike in the case of placing the tools and the respective units in a movable manner, the processes can be easily performed without considering overlapping of moving ranges of the tools and the respective units or interference therebetween when being moved.

Moreover, the laser quenching step S7 for quenching the workpiece W by irradiating the workpiece W with the laser beam L serves as the surface hardening treatment step. This configuration eliminates the necessity for the deep quenching and the finishing after quenching with a large amount of processing allowing for possible cumulative errors due to the clamping operations before and after the hardening treatment. Thus, the time and cost of the processing is reduced. In addition, since the deep quenching is not needed, the laser quenching with a relatively small hardening depth can be used as the surface hardening treatment. Since the finishing with a large amount of processing is not needed, the vibration processing that is suitable for the precision microfabrication and is relatively difficult to ensure the amount of processing can be efficiently used for the finishing after quenching.

The vibration portion 50 in the vibration cutting unit 20 of the processing apparatus 1 performs longitudinal vibration and the flexural vibration. Alternatively, a vibration portion including two longitudinal oscillators may be used instead of the vibration portion 50. In this case, the two longitudinal oscillators are arranged in an L-shape or a V-shape with an angle therebetween, or in parallel (in a U-shape). A connecting member for connecting ends of the two longitudinal oscillators is provided, and the vibration cutting tool is mounted on the connecting member. At least either one of the longitudinal oscillators gives the connecting member a lateral vibration serving as a vibration in the cutting direction, and gives the connecting member a longitudinal vibration serving as a vibration in the cut-in direction, in a feeding direction, or in an intermediate direction therebetween.

Furthermore, a torsional vibration may be combined in the vibration of the vibration portion 50.

A vibration portion for generating the flexural vibration alone may be used instead of the vibration portion 50 for generating the elliptical vibration.

The vibration may be given to the workpiece W, or may be given to the vibration cutting tool and the workpiece W.

In the processing before quenching, processing other than the cutting, such as bonding or welding, may be performed in addition to the cutting by the cutting tool 12. If the finishing before quenching is included in the processing before quenching in addition to the rough processing, processing other than the cutting may be performed in the processing before quenching in addition to the cutting.

At least two of the cutting tool 12, the quenching unit 16, and the vibration cutting unit 20 may be placed on the same turret so as to be switchable for the workpiece W, or may be mounted on magazines of the same automatic tool changer (ATC) so as to be switchable for the workpiece W.

The tool clamping mechanism may supply power to the vibration cutting unit 20 in a non-contact manner using non-contact transformer coupling. In this case, the wiring portion 52 can be embedded in the machine. Hence, interference or the like of the wiring portion 52 can be prevented. In addition, the vibration cutting unit 20 can be easily mounted on a magazine of the same automatic tool changer (ATC) as that of the cutting tool 12, and the vibration cutting unit 20 can be easily used by being controlled in rotational position about an A-axis serving as a rotational axis parallel to the X-axis.

The cutting tool 12 may be held by a pre-quenching cutting tool unit including a joint portion. In this case, the pre-quenching cutting tool unit may be clamped by the tool clamping mechanism 31.

Instead of the tool clamping mechanism 31, a unit clamping mechanism may be provided that does not clamp the tool, but includes an engaging portion to be engaged with an engaged portion provided at each of the units.

The main spindle head may include such a unit clamping mechanism in addition to the tool clamping mechanism, and each of the units may be clamped by the unit clamping mechanism at the engaged portion instead of the joint portion. In this case, the joint portion may be omitted.

The tool clamping mechanism 31 (for clamping the pre-quenching processing tool and each of the units) may move relative to the workpiece W in a manner other than the above-described manner as long as being relatively movable. For example, the workpiece clamping mechanism 32 may be movable in at least one of the X-, Y-, and Z-axis directions, the workpiece W need not rotate about the C-axis, the workpiece W may be clamped in the stationary state without moving, the workpiece W may rotate about the B-axis or the A-axis serving as the rotational axis parallel to the X-axis, the main spindle head 4 (tool clamping mechanism 31) need not rotate about the B-axis, the main spindle head 4 need not move in the Y-axis direction, and the main spindle head 4 may rotate about the C-axis. Each of the units may be movably or rotatably mounted on the main spindle head 4.

In the first embodiment described above, the quenching unit and the vibration cutting unit are included in the lathe-type combined processing machine. However, unlike this embodiment, these units may be included in the machining center or a five-axis processing machine based thereon, or each of the units may be included in other machine tools.

The various processes, and components, sequences, shapes, arrangements, numbers, presence or absence, materials, types, and the like of members and portions may be changed as appropriate. That is, for example, the tailstock 10 may be omitted, the workpiece may be unsupported by the tailstock depending on the type of process, the clamping of the workpiece at S1 and the clamping of the cutting tool 12 to the main spindle head 4 at S3 may be performed simultaneously or in reverse order, the positions of the quenching unit accommodating portion 18 and the vibration cutting unit accommodating portion 22 may be swapped, the joint portion 54 may be a joint that pulls in a tapered surface with a pull stud, a double-face contact tool clamping mechanism, such as that capable of clamping a double-face contact hollow taper shank (HSK), may be used, a connecting mechanism operated by moving in and out of a steel ball, such as that found in a pallet mounting unit, may be used as the tool clamping mechanism, instead of a general tool changing mechanism, the central wavelength, the irradiation width, and the output of the laser beam L may be variously set, the operation panel 26 and the display portion 24 thereof may be omitted or separately provided, the control unit 28 may be separately provided, the control unit 28 may be provided individually for each of the units and the like, the machine frame 3 may be omitted, and at least either one of the clamping mechanisms may be something other than the chuck.

A processing apparatus 101 according to a second embodiment of the present invention will be described by referring to the drawing.

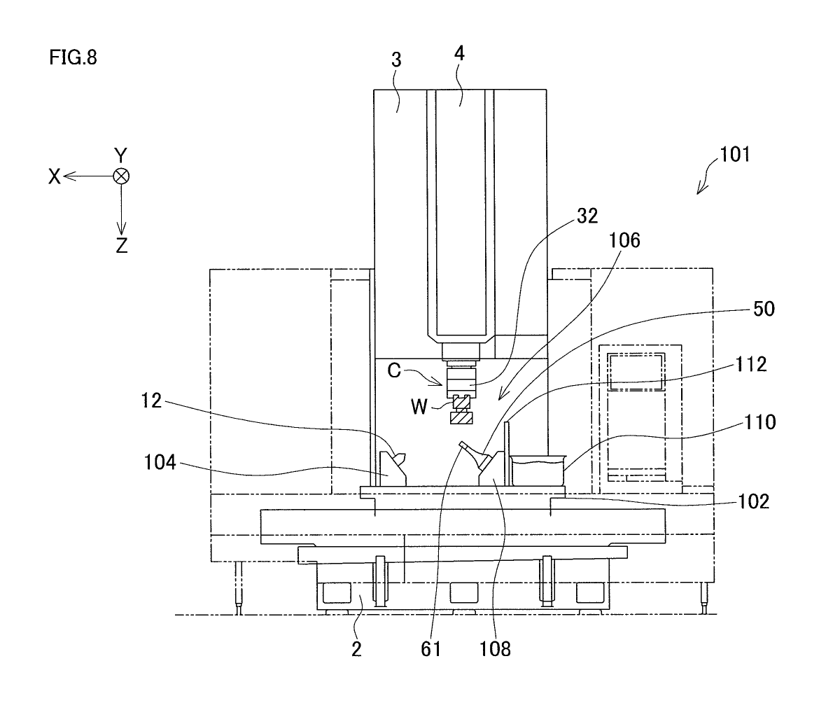

FIG. 8 is a front view of the processing apparatus 101 according to the second embodiment of the present invention.

The processing apparatus 101 is based on a machining center, and can be considered to be a vertically inverted vertical boring and turning mill-type (inverted lathe-type) machine tool. In the processing apparatus 101 according to the second embodiment, the same reference numerals will be assigned to the same members, portions, and the like as those of the processing apparatus 1 of the first embodiment, and the description thereof will not be repeated.

The processing apparatus 101 includes a main spindle (not illustrated except the lower end portion thereof) that is built into the main spindle head 4 and that is movable in the Y-axis direction (direction orthogonal to the plane of FIG. 8) and the Z-axis direction (upper-lower direction of FIG. 8) and rotatable about the C-axis. The lower end portion of the main spindle is provided with the workpiece clamping mechanism 32 for holding the workpiece W.

The processing apparatus 101 includes a tool rest 102 movable in the X-axis direction (right-left direction of FIG. 8) on the bed 2. At the left portion of the upper side of the tool rest 102, the cutting tool 12 is fixed to a cutting tool base 104 so as to be oriented toward an intermediate direction between the X-axis direction and the Z-axis direction (upper right direction of FIG. 8), and, at the right portion of the upper side of the tool rest 102, the vibration portion 50 of a vibration cutting unit 106 is fixed to a vibration portion base 108 so as to be oriented toward an intermediate direction between the X-axis direction and the Z-axis direction (upper left direction of FIG. 8). The vibration cutting unit 106 includes the vibration portion 50, the vibration portion base 108, and a wiring portion (not illustrated).

In addition, a plating bath 110 serving as the surface hardening treatment unit is fixed on the right side of the vibration portion base 108 on the upper side of the tool rest 102. In the present embodiment, the plating bath 110 is a chromium plating bath. A partition 112 is provided between the plating bath 110 and the vibration cutting unit 106 (vibration portion 50).

### Operation Example and so Forth

First, the processing apparatus 101 moves, while rotating, the workpiece W (relative to the cutting tool 12) through the workpiece clamping mechanism 32 and the tool rest 102 to bring the workpiece W into contact with the cutting tool 12, and cuts (turns) the workpiece W (processing step). Since the cutting tool 12 is oriented toward the intermediate direction between the X-axis direction and the Z-axis direction, one cutting tool 12 can process an end face (face along the XY-plane) and a longitudinal face (face along the YZ-plane).

Then, the processing apparatus 101 moves the workpiece W relative to the plating bath 110 through the workpiece clamping mechanism 32 and the tool rest 102, and immerses the workpiece W in the plating solution in the plating bath 110 (plating step as the surface hardening treatment step).

Subsequently, the processing apparatus 101 vibrates the vibration cutting tool 61 of the vibration portion 50, and furthermore, the processing apparatus 101 moves the workpiece W relative to the vibration portion 50 in the same manner as in the case of the cutting tool 12, and applies the vibration cutting tool 61 to the workpiece W to finish the plated workpiece W (finishing step).

If cutting chips generated in the processing before plating and the finishing move toward the plating bath 110, the movement is blocked by the partition 112. As a result, the cutting chips are prevented from being mixed in the plating bath 110.

The processing apparatus 101 according to the second embodiment includes the workpiece clamping mechanism 32 for clamping the workpiece W, the cutting tool 12 for cutting the workpiece W, the plating bath 110 for plating the workpiece W, and the vibration cutting unit 106 capable of vibrating the distal end 60 with the vibration cutting tool 61 mounted thereon. The cutting tool 12, the plating bath 110, and the vibration cutting unit 106 are movable relative to the workpiece W. The vibration cutting unit 106 performs the finishing by applying the vibration cutting tool 61 to the workpiece W while vibrating the vibration cutting tool 61. As a result, the rough processing, the surface hardening treatment (plating), and the finishing can be performed for one clamping of the workpiece W. Thus, the surface hardening treatment and the finishing are performed more accurately, the processing apparatus 101 is reduced in size due to the common use of the moving mechanism, and, combined with the effect of reduction in the number of times of clamping, the time and cost of the processing is reduced.

The plating bath 110 for applying the plating to the workpiece W serves as the surface hardening treatment unit. This configuration eliminates the necessity for thick plating and the finishing after quenching with a large amount of processing allowing for possible cumulative errors due to the clamping operations for the cutting processes before and after the hardening treatment. Thus, the time and cost of the processing is reduced. In addition, since the thick plating is not needed, the amount of plating material used is reduced. Since the finishing with a large amount of processing is not needed, the vibration processing that is suitable for the precision microfabrication and is relatively difficult to ensure the amount of processing can be efficiently used for the finishing after plating. Generally, in the case of applying high-hardness plating (such as high-hardness chromium plating) to ensure high hardness, in order to increase the thickness of the plated layer to 50 micrometers or larger, the plating is once applied to such a level of thickness, and, after polishing the surface to flatten pits (depressions) on the surface, the plating is applied again. Thus, the polishing and the plating are repeated as appropriate. However, in the case of the processing apparatus 101 in which the processing before plating and the finishing after plating are aggregated, such repetition is impractical, and practically, only thin plating to the above-described level of thickness is applied. At this time, if sufficient accuracy of the finishing after plating is not obtained, the plating may be partially so thin as to be incapable of ensuring sufficient hardness, or the processing may be applied up to the thickness of the plating or deeper so as to partially remove the plating. However, since the processing apparatus 101 ensures sufficient accuracy of the finishing, the processing apparatus 101 is also suitable for the high-hardness plating.

In addition to including the same modifications as those of the processing apparatus 1 according to the first embodiment as appropriate, the processing apparatus 101 according to the second embodiment includes the following modifications as appropriate.

A plurality of cutting tools 12 and a plurality of vibration portions 50 may be arranged while being oriented in the same direction as each other or in different directions from each other.

Instead of the partition 112, a cover for covering at least either the plating bath 110 or a processing space (space in which the cutting tool or tools 12 and the vibration portion or portions 50 are arranged) may be disposed. In this case, the cover may have an opening or an openable/closable door for passing, for example, the workpiece W.

A processing apparatus 201 according to a third embodiment of the present invention will be described by referring to the drawing.

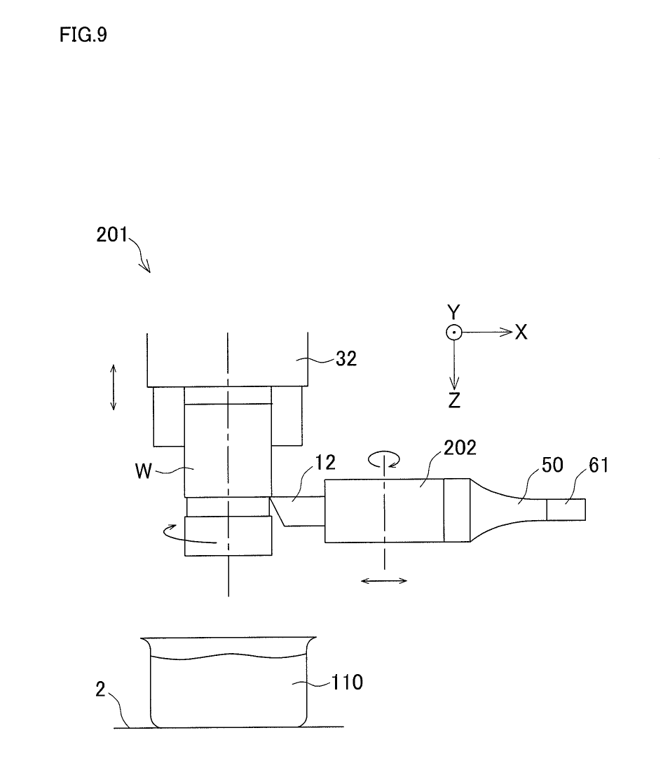

FIG. 9 is a partial schematic view of the processing apparatus 201 according to the third embodiment of the present invention.

The processing apparatus 201 is configured in the same manner as the processing apparatus 101 of the second embodiment, except in presence or absence of a movable table and in the arrangement of the various tools and the plating bath 110. In the processing apparatus 201 according to the third embodiment, the same reference numerals will be assigned to the same members, portions, and the like as those of the processing apparatus 101 of the second embodiment, and the description thereof will not be repeated.

In the processing apparatus 201, the plating bath 110 is placed on the bed 2. The processing apparatus 201 includes a turret 202 on which the vibration portion 50 (vibration cutting tool 61) and the cutting tool 12 are mounted. The turret 202 is movable in the X-axis direction, and the processing apparatus 201 can be considered to be a vertically inverted vertical boring and turning mill-type (inverted lathe-type) machine tool. The turret 202 is rotatable about the C-axis, and is capable of changing the tools (vibration cutting tool 61 and cutting tool 12) applied to the workpiece W. In the processing apparatus 201, the turret 202 and the vibration portion 50 can be considered to constitute the vibration cutting unit.

First, the processing apparatus 201 moves, while rotating, the workpiece W (relative to the cutting tool 12) through the workpiece clamping mechanism 32 and the turret 202 to bring the workpiece W into contact with the cutting tool 12, and cuts (turns) the workpiece W (processing step).

Then, the processing apparatus 201 moves the workpiece W relative to the plating bath 110 through the workpiece clamping mechanism 32, and immerses the workpiece W in the plating solution in the plating bath 110 (plating step as the surface hardening treatment step).

Subsequently, the processing apparatus 201 vibrates the vibration cutting tool 61 of the vibration portion 50 that has been changed from the cutting tool 12 by the turret 202, moves the workpiece W relative to the vibration portion 50 in the same manner as in the case of the cutting tool 12, and applies the vibration cutting tool 61 to the workpiece W to finish the plated workpiece W (finishing step).

In the same manner as the processing apparatus 101 according to the second embodiment, the processing apparatus 201 according to the third embodiment can also perform the rough processing, the surface hardening treatment (plating), and the finishing for one clamping of the workpiece W. Thus, the surface hardening treatment and the finishing are performed more accurately, the processing apparatus 201 is reduced in size due to the common use of the moving mechanism, and, combined with the effect of reduction in the number of times of clamping, the time and cost of the processing is reduced.

Since the plating bath 110 does not move (relative to the bed 2), the plating bath 110 is further stabilized constantly.

In addition to including the same modifications as those of the processing apparatus 1 according to the first embodiment and the processing apparatus 101 according to the second embodiment as appropriate, the processing apparatus 201 according to the third embodiment includes the following modifications as appropriate.

The cutting tool 12 and the vibration portion 50 may be oriented toward an intermediate direction between the X-axis direction and the Z-axis direction while being applied to the workpiece W, in the same manner as in the second embodiment.

Also in the third embodiment, the partition 112 or the cover may be placed in the same manner as in the second embodiment and the modifications thereof.

The plating bath 110 may be placed on a table that is fixed to the bed 2 and does not move.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A processing apparatus comprising:
a processing tool configured to process a clamped workpiece;
a surface hardening treatment unit configured to apply a surface hardening treatment to the workpiece; and
a vibration processing unit configured to vibrate a distal end with a vibration processing tool mounted thereon, wherein
the processing tool, the surface hardening treatment unit, and the vibration processing unit are movable relative to the workpiece, and
the vibration processing unit is configured to perform finishing by applying the vibration processing tool to the workpiece while vibrating the vibration processing tool.

2. The processing apparatus according to claim 1, wherein the vibration processing unit is configured to elliptically vibrate the vibration processing tool.

3. The processing apparatus according to claim 1, further comprising a unit clamping mechanism that is movable relative to the workpiece and is configured to clamp the processing tool, the surface hardening treatment unit, and the vibration processing unit.

4. The processing apparatus according to claim 1, wherein the surface hardening treatment unit is a quenching unit configured to quench the workpiece by irradiating the workpiece with a laser beam.

5. The processing apparatus according to claim 1, wherein the surface hardening treatment unit is a plating bath for plating the workpiece.

6. A processing method comprising steps of:
(a) processing a workpiece in a clamped state;
(b) applying a surface hardening treatment to a surface of the workpiece;
(c) finishing the surface of the workpiece by applying a vibration processing tool to the surface while vibrating the vibration processing tool; and
(d) unclamping the workpiece.

7. The processing method according to claim 6, wherein the vibration processing tool elliptically vibrates.

8. The processing method according to claim 6, wherein
step (a) is performed with a processing tool;
step (b) is performed with a surface hardening treatment unit;
step (c) is performed with a vibration processing unit configured to vibrate the vibration processing tool; and
the processing tool, the surface hardening treatment unit, and the vibration processing unit are moved relative to the workpiece by a unit clamping mechanism on which the processing tool, the surface hardening treatment unit, and the vibration processing unit are mountable.

9. The processing method according to claim 6, wherein step (b) is performed by quenching the workpiece by irradiating the workpiece with a laser beam.

10. The processing method according to claim 6, wherein step (b) is performed by plating the workpiece.
